(19) United States
(12) Patent Application Publication
(10) Pub. No.: US 2009/0317071 A1
(43) Pub. Date: Dec. 24, 2009

(54) System for the Remote Control of Setting Up a Supporting Head for Optical and/or Photo-Cinematographic Equipment

(76) Inventor: Laurent David, Breuillet (FR)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 12/226,753

(22) PCT Filed: Apr. 27, 2007
(86) PCT No.: PCT/EP2007/003749

§ 371 Date: Jan. 23, 2009

(30) Foreign Application Priority Data
Apr. 27, 2006 (IT) PD2006A000162

(51) Int. Cl. G03B 17/00

(52) U.S. Cl. 396/428

(57) ABSTRACT

This invention describes a system for the remote control of setting up an adjustable head for optical and/or photo-cinematographic equipment comprising an adjustable head for mounting by adjustable setting-up of optical and/or photo-cinematographic equipment, at least one servomechanism for locking and/or unlocking and/or setting up a movable part of the head in relation to a fixed part thereof, as well as remote control means of said servomechanism for setting up the head comprising at least one pushbutton control, remote in relation to the servomechanism, that can be operated by the user while he is holding said equipment.

### TECHNICAL FIELD

This invention relates to a system for the remote control of setting up an adjustable supporting head for optical and/or photo-cinematographic equipment according to the pre-characterising clause of main claim 1.

### BACKGROUND ART

Supporting heads that can be adjusted in a plurality of directions are known to be used for mounting and adjusting in the desired manner (henceforth “setting up”) a still camera, video camera or other optical and/or photo-cinematographic equipment on a support therefor such as a tripod, stand or similar supports known in the technical sector in question.

In known solutions, these supporting heads usually afford one or more set-up possibilities (generally two for video cameras, three for still cameras) about the same number of axes, and the possible connections between the head and support capable of achieving these adjustments are of different types, such as one or more articulated joints, preferably of a ball or cylindrical type, provided on the head and/or support in order to adjust the position thereof.

These articulated joints can be locked in the desired spatial position by applying locking by friction forces, exerted for example by levers or pressure screws acting directly on the joint elements or by interposing resilient springs.

Other known solutions for locking the head involve the use of means to apply a hydrostatic-type load, for example comprising hydraulic piston devices onto which a hydraulic thrust is transferred by adjusting the pressure inside the piston's slide chamber.

In both cases, setting up the head requires manual intervention by the user in order to achieve the correct position, or the user must operate various set-up and locking controls (be they screws or pistons) in order to achieve and maintain the satisfactory position.

This intervention, however, means that it is impossible for the operator to set up/lock the supporting head and at the same time take the photograph or photo-cinematographic shot, because the hand/s used to take the photograph or shot are operating set-up and/or locking controls. This restriction is particularly counter-productive when particular speed is required to take the photo or shot.

In the photographic sector, there is thus a need for a control system to operate the set-up of an adjustable head so that the latter can be operated by the user without interfering with the operation of taking a photograph or a photo-cinematographic shot.

### DISCLOSURE OF THE INVENTION

The problem that lies at the heart of the present invention is to provide a system for the remote control of a device to set up an adjustable head for optical and/or photo-cinematographic equipment which is structurally and operationally designed so as to overcome the limits of the said known art.

This problem is solved by the invention by means of a system for the remote control of the setting up device of an adjustable head for optical and/or photo-cinematographic equipment made in accordance with the claims below.

### BRIEF DESCRIPTION OF THE DRAWINGS

Further features and advantages of the invention will emerge from the following detailed description of four preferred embodiments which are shown by way of non-limiting examples in the accompanying drawings, in which:

FIG. 1 is a perspective view of a first embodiment of a system for the remote control of setting up an adjustable head for optical and/or photo-cinematographic equipment made in accordance with the present invention;

FIG. 2 is a perspective view of a second embodiment of a system for the remote control of setting up an adjustable head for optical and/or photo-cinematographic equipment made in accordance with the present invention;

FIG. 3 is a perspective view of a third embodiment of a system for the remote control of setting up an adjustable head for optical and/or photo-cinematographic equipment made in accordance with the present invention;

FIG. 4 is a perspective view of a fourth embodiment of a system for the remote control of setting up an adjustable head for optical and/or photo-cinematographic equipment made in accordance with the present invention.

### BEST MODES FOR CARRYING OUT THE INVENTION

In the figures, 1 indicates as a whole a system for the remote control of setting up an adjustable head for optical and/or photo-cinematographic equipment, according to the present invention.

The system 1 comprises a supporting head 8 for optical and/or photo-cinematographic equipment, capable of adjusting in space (henceforth “setting up”) a plate 7 to which the optical and/or photo-cinematographic equipment, indicated in all the figures by 50, is fixed in relation to a support 2.

The removable fixing of the equipment 50 on the plate 7 is achieved by connection means of a type known within the sector concerned and forming the subject-matter, inter alia, of patent applications by the present Applicant. For example, the plate 7 can have a screw connection capable of screwing into a corresponding portion of the above-mentioned equipment 50 so as to fix it to the plate.

The head 8 is furthermore preferably removably fixable to the structure of the support 2 by means of a connection (not shown) in a known way within the field.

The head 8 comprises at least one articulated joint 10, 10′, 10″ which enables connection between head 8 and support 2 and is capable of adjusting the inclination of the head 8 about a certain number of axes. The type of joint chosen depends on the type of equipment 50 used and the conditions of use thereof. The number of joints provided for one head 8 (for example one joint for each possible axis of inclination of the head 8) and their type has no influence as regards the application of the present invention which can be adapted to any type and number of preferred joint.

In each head 8 it is possible to identify a first and a second element, shown by 6a and 7a respectively, movably connected together. The first element 6a is fixed in relation to the support 2 whereas the second element 7a is movable in relation thereto.

In the preferred embodiments described below, the support 2 is represented by a tripod 2 including a crosspiece 3 in which three legs 4 converge and are articulated. It must be understood that the disclosure of the present invention applies to any type of head 8 regardless of the type of support (tripod, one-legged prop, stand, etc.) to which the head is additionally connected.

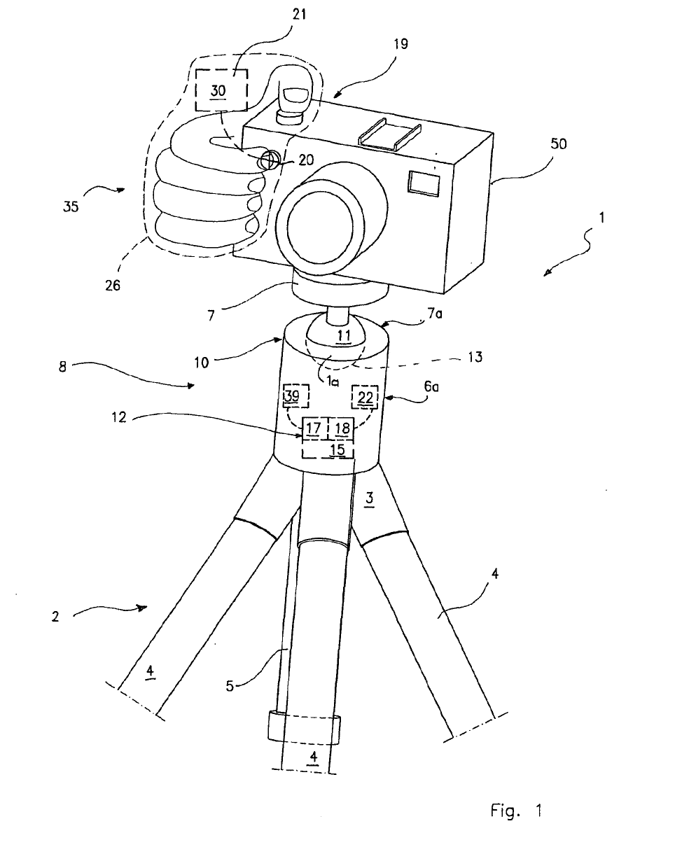

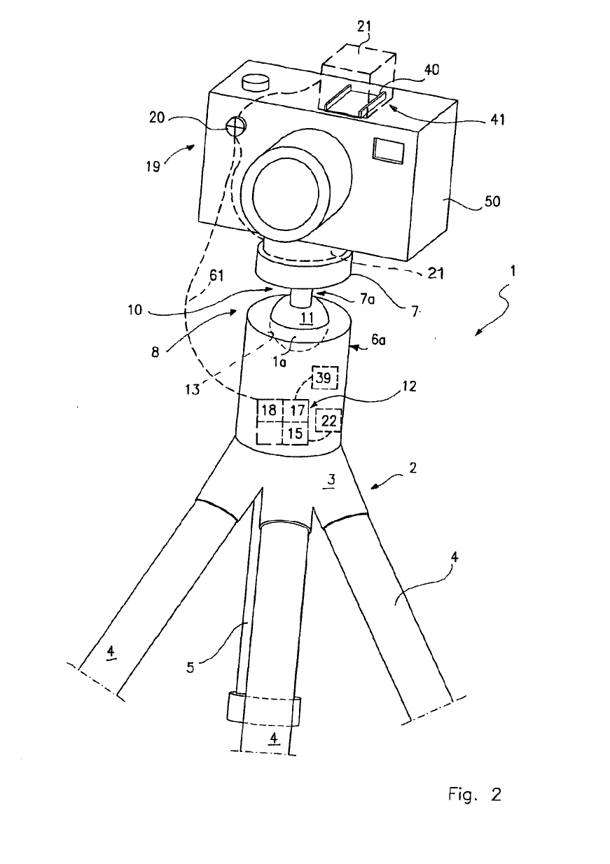

Purely by way of example, with reference to two first preferred embodiments of the invention shown in FIGS. 1 and 2, the tripod 2 also comprises a tubular cylindrical column 5 mounted sliding in a central hole (not visible) in the crosspiece 3 and held sliding therein in an adjustable manner.

At one axial end, column 5 has the fixing plate 7 for equipment 50, such as a still camera; the supporting head 8, preferably motorised, is interposed between the fixing plate 7 and the equipment 50.

The supporting head 8 is connected to the column 5 by means of a ball type articulated joint 10, to enable the adjustable set up of the equipment 50 along the three axes of rotation X, Y, Z.

In this example, the second movable element 7a of the head 8 comprises a ball-and-socket joint 11 that can be connected to the plate 7, while the first fixed element 6a comprises a cavity 13 provided in a main body 1a of the head (that can be connected to the tripod 2) 8 and constitutes a rotating seat to house the ball-and-socket joint 11, so as to ensure the ball joint connection between the equipment-connection plate 7 and the portion of the head 8 connected to the tripod 2.

An example of this type of joint is given in the present Applicant's Italian Patent application No. PD2004A000227.

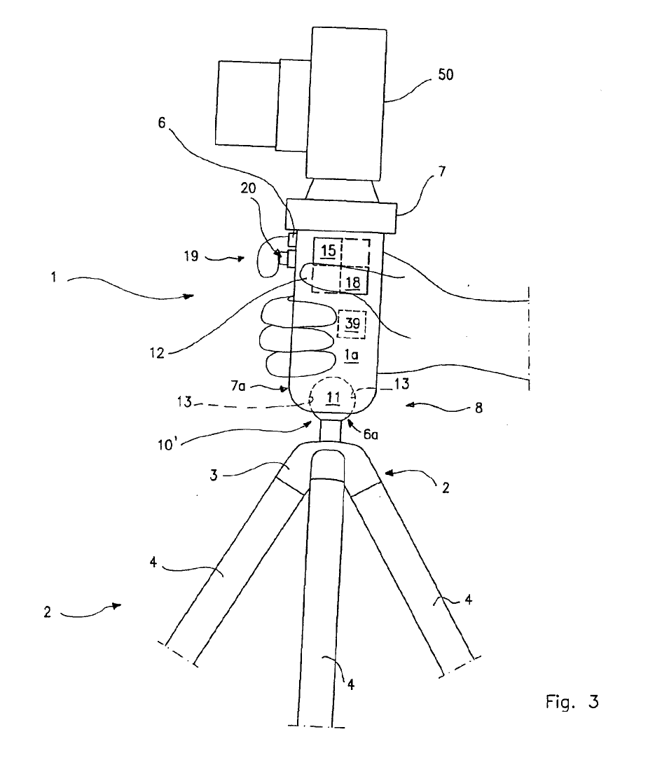

An additional so-called “joystick” ball joint 10′, in which the ball-and-socket joint 11 now represents the fixed element 6a and the body with the cavity 13 the movable element 7a (inverted compared to the preceding embodiment), is used in the preferred embodiment of the invention shown in FIG. 3, in which the tripod 2 does not comprise a central column 5, but the joint 10′ is directly positioned on the crosspiece 3. An example of this type of joint is shown in the present Applicant's Italian Patent application No. PD2003A00019.

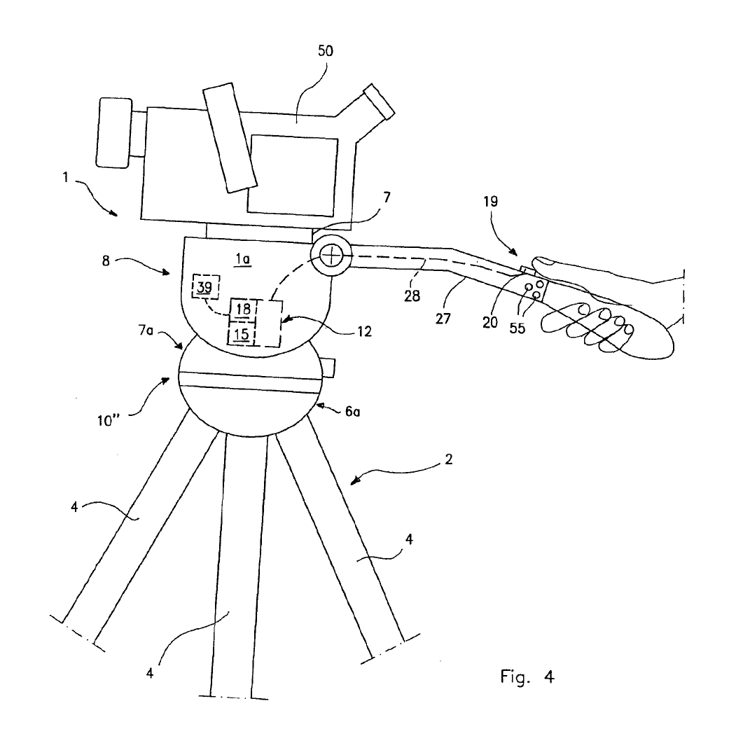

A different type of joint 10″ is by contrast shown in the embodiment of the invention shown in FIG. 4, in which a supporting head 8 is shown connected to a tripod 2 by means of a joint 10″ particularly suitable in the case of setting up video cameras. A special support for this type of equipment must in fact ensure the movement thereof about two axes that are at right angles to each other, one horizontal, so-called “tilt”, with which the inclination of the equipment is adjusted in relation to the horizon and one vertical, so-called “panoramic”, with which the angular sighting is moved along the horizon. This type of joint is shown as an example in the present Applicant's Italian Patent application No. PD2005A000143.

Other types of joints known in this field are, however, covered by the present invention.

In all of the preferred examples shown, in which different types of supporting heads 8 are shown connected to different supports 2 by means of joints 10, 10′, 10″ having different functions, the system 1 according to the invention also comprises a servomechanism 12 including actuator means 15 for locking/unlocking the said joint 10, 10′, 10″.

These locking/unlocking actuator means 15 are capable of locking and/or unlocking the movement of the first fixed element 6a of the supporting head 8 in relation to the second movable element 7a in order to maintain and/or change the desired set-up of the still/video-camera 50. In the case of heads 8 articulated to the support 2 by means of a plurality of joints 10, 10′, 10″, every first and second element 6a, 7a will comprise unlocking/locking actuator means 15.

The locking/unlocking actuating means 15 comprise means to apply the load to lock the head 8, for example pins that are movable by means of knobs or levers (both not shown), or other known means within the field, for example magnetic means, which by a friction force lock the movement of the supporting head 8. Alternatively, the means for applying the friction locking load on the articulated joint 10, 10′, 10″ can also for example comprise oil-pressure piston devices (not shown) onto which a thrust is transferred, such thrust being achieved by adjusting the pressure in the sliding chamber of the piston.

In addition, the servomechanism 12 may preferably comprise means 18 to set up the joint 10, 10′, 10″ so as to adjust the position of the equipment 50 about one or more axes of rotation. These means adjust the inclination of the joint, by moving the movable joint element in relation to the fixed joint element, along one or more axes so as to obtain the desired set-up of the equipment 50.

The setting-up means 18 may include, inter alia, sliding means 17 of the column 5, if the support 2 has one, in order to adjust the desired height of the column 5 and therefore of the photo/cinematographic equipment 50.

The servomechanism 12, in particular the unlocking/locking actuator means 15, and/or the setting-up means 18 are connected to one or more motor means (not shown) for the required movement.

The servomechanism 12 is also connected to a power source 39, for example a battery or other supply, in order to power the motor means for the above-mentioned movement. The power source 39 may be built into the joint 10,10′,10″ (as shown in accompanying FIGS. 1 to 4) or may be located elsewhere, for example in the support 2 or in another pre-selected location. An example of a possible location of a battery source is shown in the present Applicant's Italian Patent application No. PD2005A000249.

The system 1 also comprises, according to one of the main characteristics of the invention, remote control means 19 of the servomechanism 12 for the control thereof, or for the remote control of locking/unlocking the motorised head 8 and optionally for controlling the set-up of the equipment 50, or to move the equipment 50 along one or more axes of rotation of the positioning joint 10,10′,10″, or even for movement in axial translation to set up the column 5, through setting-up means 18.

In detail, the remote control means 19 comprise a pushbutton control 20, positioned as described below.

The pushbutton control 20 is connected to a transmitter 21 to transmit the command given through it to a receiver 22, which can for example be built into the articulated ball joint 10, 10′, 10″, as in the preferred embodiments shown in FIGS. 1 and 2.

The receiver 22 is in turn connected, for example electrically, to the servomechanism 12, so that the servomechanism is interlocked with the remote control means 19 and the locking/unlocking and/or set-up commands can be given to the servomechanism 12 via the pushbutton 20 which can be physically relatively far away from the servomechanism 12.

The transmitter 21 is for example an infrared or radiofrequency transmitter. As an alternative to a transmitter 21, an electrical wire connects the pushbutton control 20 to the receiver 22 so as to electrically transmit the commands given via the pushbutton control.

The user may be able to operate the pushbutton control, thanks to its position, while he is holding the equipment 50, since it is located in an appropriate position for it to be used at the same time as the equipment 50 is being used.

According to a first preferred embodiment of the system 1 shown in FIG. 1, the remote control means 19 comprise a remote control support 35, on which is located the pushbutton control 20, which can be placed between the user's fingers and the body of the equipment 50 when the user is holding the latter.

Advantageously, the remote control support 35 constitutes a technical glove 26, into which both the pushbutton control 20 and the transmitter 21 are built, thus completely releasing the position of the hand from the equipment 50. In particular, the pushbutton control 20 is located at the end of a finger when the glove is being worn.

An additional power source 30 may also be built into the glove 26 if necessary.

By pressing the pushbutton control 20 inside the glove 26, a signal emitted by the transmitter 21 reaches the receiver 22 located inside the joint 10 so as to control the servomechanism 12, also located in the joint 10, for example to activate the locking/unlocking actuator means 15 in order to lock or unlock the head 8 and thus respectively lock or change its angle.

In another variant of the invention, not shown, the transmitter 21 and the additional power source 30 are located in a removable manner on the equipment 50 (in the embodiment shown in FIG. 1 a still camera).

In the second embodiment of this invention, shown in FIG. 2, the system 1 comprises the remote control means 19 including the pushbutton control 20 arranged in a removable manner on the equipment 50. In particular, the pushbutton control 20 is connected to the equipment 50 by an adhesive means or similar anchoring means. Similarly, the transmitter 21 (shown in dotted lines in FIG. 2) is arranged on the equipment by gripping means, such as a slide 40 that can be inserted in the flash-holder guide 41. Alternatively, the transmitter 21 can be mounted on the plate 7 beneath the equipment 50 (see the dotted outline in FIG. 2).

In another preferred embodiment of the invention in which a connection is provided via an electrical wire (shown by the dotted line 61 in FIG. 2) between the pushbutton 20 and the receiver 22, arranged near the joint 10′, the presence of the transmitter 21 is not required.

In this preferred embodiment too, shown in FIG. 2, the servomechanism 12, arranged on the joint 10, is relatively far away from the remote control means 19. The user can hold the still camera 50, possibly make the shot, and at the same time control set-up and/or locking/unlocking because the pushbutton control 20 is positioned on the said camera.

Alternatively, the system 1 comprises remote control means 19 arranged on the motorised head 8 near the fixing plate 7. In particular, as shown in FIG. 3, the pushbutton control 20 is arranged on the said joint, although in a remote position in relation to the servomechanism 2. In this case, next to the pushbutton control 20 there is an additional pushbutton, the shutter button 6, to control the shutter of the equipment 50, made as part of a kit to remotely control the shutter of photographic equipment and suchlike comprising a shutter remote-control device preferably of an electrical or electronic type. It is precisely by means of this shutter pushbutton 6 that the equipment 50 is activated and a photographic shot is taken. An example of this kit for the remote control of taking shots is given in the Applicant's Italian Patent application No. PD2004A000002.

By pressing the pushbutton 20, the servomechanism 2 is commanded to activate the locking/unlocking actuator means and, if necessary, to set up the joint 10′. Thus both the joint 10′ and the equipment 50 are controlled by the same hand.

In the fourth embodiment of this invention, shown in FIG. 4, the system 1 comprises a joint 10″ that is especially for setting up video cameras 50.

The remote control means 19 including the pushbutton 20 are located on a handle 27 that extends from the body la of the head 8. The handle 27 also comprises the transmitter 21 connected to the receiver 22 (neither of which are shown in FIG. 4) which is in turn connected to the servomechanism 12, built into the articulated joint 10″ as in the preceding embodiments. Alternatively, an electrical wire 28 is provided which connects the pushbutton control 20 to the servomechanism 12. On the handle 27, near the said pushbutton control 20, there may be additional pushbuttons 55 relating to the control of the video camera 50. Consequently, using the same hand, it is possible to manoeuvre the video camera via its control buttons 55 and to set up and/or lock/unlock it by means of pushbutton 20.

Although in the above-described embodiments a pushbutton control 20 is shown that comprises only one pushbutton, it may comprise any desired number of pushbuttons, as well as a touch screen or levers, so as to activate the servomechanism 12 in the desired manner by selecting alternately for example the desired means, such as the locking/unlocking 15 or set-up means 18 of the joint 10, 10′, 10″ and controlling the extent of movement thereof, or the inclination in relation to the axes and/or the height of the column 5. Therefore, the term “pushbutton control” refers generally to any element (be it a pushbutton, touch screen or lever, etc.) that can be activated by pressing or touching.

In addition, any combination of the above-described elements is included in the disclosure of the present invention: a pushbutton control 20 applied on a handle 27 can also be provided in joints 10 of the ball type like the one shown in FIG. 1, not only in joints 10″ of the type shown in FIG. 4, or vice versa in the joints 10″ shown in FIG. 4 the control device 19 may alternatively be arranged in a glove 26 similar to that shown in FIG. 1.

The invention thus solves the problem posed by offering numerous advantages compared to the said known art.

In the first place it is possible to set up the equipment by a remote control that enables the set-up and possible control of the equipment to be performed contemporaneously.

It is also possible to perform locking and/or unlocking and/or setting up operations with very little effort on the part of the operator, since the servomechanism is responsible for these operations without direct mechanical connection with the pushbutton control.

1. System for the remote control of setting up an adjustable head for optical and/or photo-cinematographic equipment comprising: an adjustable head for mounting by adjustable setting-up of optical and/or photo-cinematographic equipment, at least one servomechanism for locking and/or unlocking and/or setting up a movable part of said head in relation to a fixed part thereof, remote control means of said servomechanism for setting up said head comprising at least one pushbutton control, remote in relation to said servomechanism, that can be operated by the user while he is holding the equipment.

2. System for the remote control of setting up an adjustable head for optical and/or photo-cinematographic equipment according to claim 1, wherein said pushbutton control is located on said motorised head near a fixing plate of the equipment.

3. System for the remote control of setting up an adjustable head for optical and/or photo-cinematographic equipment according to claim 1, wherein said control means comprise a remote control support including said pushbutton control which can be placed between the user's fingers and the equipment when the user is holding the latter.

4. System for the remote control of setting up an adjustable head for optical and/or photo-cinematographic equipment according to claim 3, wherein said remote control support is a technical glove.

5. System for the remote control of setting up an adjustable head for optical and/or photo-cinematographic equipment according to claim 1, wherein said head comprises a handle which extends from a body of the head and wherein said control means are arranged on the handle.

6. System for the remote control of setting up an adjustable head for optical and/or photo-cinematographic equipment according to claim 1, wherein said pushbutton control comprises fixing means so as to be removably fixed to said equipment.

7. System for the remote control of setting up an adjustable head for optical and/or photo-cinematographic equipment according to claim 1, wherein said control means include a transmitter to send a control signal from the pushbutton control to said servomechanism.

8. System for the remote control of setting up an adjustable head for optical and/or photo-cinematographic equipment according to claim 7, wherein the transmitter is built into a technical glove.

9. System for the remote control of setting up an adjustable head for optical and/or photo-cinematographic equipment according to claim 7, wherein said transmitter is built into a handle.

10. System for the remote control of setting up an adjustable head for optical and/or photo-cinematographic equipment according to claim 7, wherein the transmitter is positioned on said head near a fixing plate of the equipment.

11. System for the remote control of setting up an adjustable head for optical and/or photo-cinematographic equipment according to claims 7, wherein said transmitter is a radiofrequency or infrared transmitter.

12. System for the remote control of setting up an adjustable head for optical and/or photo-cinematographic equipment according to claim 1, wherein the control means include a transmitter and wherein said transmitter comprises gripping means to be removably fixed to the equipment.

13. System for the remote control of setting up an adjustable head for optical and/or photo-cinematographic equipment according to claim 1, wherein the head comprises at least one articulated joint that enables connection between the head and a support and is capable of adjusting the inclination of said head about a given number of axes.

14. System for the remote control of setting up an adjustable head for optical and/or photo-cinematographic equipment according to claim 13, wherein the joint is a ball joint.

15. System for the remote control of setting up an adjustable head for optical and/or photo-cinematographic equipment according to claim 13, wherein said servomechanism is positioned in said joint.

16. System for the remote control of setting up an adjustable head for optical and/or photo-cinematographic equipment according to claim 1, wherein the remote control means are connected by means of an electrical wire to said servomechanism.

17. System for the remote control of setting up an adjustable head for optical and/or photo-cinematographic equipment according to claim 6, including a receiver connected to said servomechanism capable of receiving signals sent by the transmitter.

18. System for the remote control of setting up an adjustable head for optical and/or photo-cinematographic equipment according to claim 16, wherein a receiver is built into said head.

19. System for the remote control of setting up an adjustable head for optical and/or photo-cinematographic equipment according to claim 1, comprising a power source and wherein the servomechanism is connected to said power source.

20. System for the remote control of setting up an adjustable head for optical and/or photo-cinematographic equipment according to claim 19, wherein the power source is built into said head.

21. System for the remote control of setting up an adjustable head for optical and/or photo-cinematographic equipment according to claim 1, wherein the servomechanism comprises locking/unlocking actuator means of the movable part of the head in relation to the fixed part that can be controlled by said remote control means.

22. System for the remote control of setting up an adjustable head for optical and/or photo-cinematographic equipment according to claim 21, wherein the locking/unlocking actuator means include means to apply a friction locking load to the joint.

23. System for the remote control of setting up an adjustable head for optical and/or photo-cinematographic equipment according to claim 1, wherein the servomechanism comprises setting-up means of the movable part of said head in relation to the fixed part capable of controlling a movement of the movable part (along one or more axes of rotation of said articulated joint, said setting-up means being controllable via the remote control means.

24. System for the remote control of setting up an adjustable head or optical and/or photo-cinematographic equipment according to claim 23, wherein the setting-up means comprise sliding means of a column, capable of controlling an axial translation movement of a column inserted sliding in a crosspiece of a tripod supporting the equipment, said sliding means being controllable by said remote control means.
